(19) United States
(12) Patent Application Publication
(10) Pub. No.: US 2026/0015033 A1
(43) Pub. Date: Jan. 15, 2026

(54) DRIVE UNIT AND METHOD FOR MANUFACTURING DRIVE UNIT

(71) Applicant: DENSO CORPORATION, Kariya-city (JP)

(72) Inventors: Takayoshi SUZUKI, Kariya-city (JP); Kiyoshi FUJII, Kariya-city (JP); Shuji KURAMITSU, Kariya-city (JP); Yoshinori AKITSU, Kariya-city (JP); Norihisa ITO, Kariya-city (JP); Katsuji KAWAI, Kariya-city (JP); Haruki AMANO, Kariya-city (JP)

(21) Appl. No.: 19/332,014

(22) Filed: Sep. 17, 2025

Related U.S. Application Data
(63) Continuation of application No. PCT/JP2024/008274, filed on Mar. 5, 2024.

(30) Foreign Application Priority Data
Mar. 21, 2023 (JP) 2023-044834

(51) Int. Cl. B62D 5/04; B60K 7/00; B60L 15/00

(52) U.S. Cl. CPC B62D 5/0406; B60K 7/0007; B60L 15/007; B60L 2240/421

(57) ABSTRACT

An electric vehicle, which includes a drive wheel, has a maximum speed of 60 km/h or lower. The drive unit includes: a shaft that is configured to apply a rotational drive force to the drive wheel; an electric motor that includes a plurality of stator windings and a rotor configured to rotate the shaft; an inverter that is electrically connected to the plurality of stator windings and is configured to supply an electric current to the plurality of stator windings when a switching control operation of the inverter is executed; and a housing that receives the electric motor and the inverter. The electric motor is configured to operate as an electric power steering motor for electric power steering in a vehicle that is configured to travel on public roads.

### CROSS REFERENCE TO RELATED APPLICATIONS

This application is a continuation application of International Patent Application No. PCT/JP2024/008274 filed on Mar. 5, 2024, which designated the U.S. and claims the benefit of priority from Japanese Patent Application No. 2023-044834 filed on Mar. 21, 2023. The entire disclosures of all of the above applications are incorporated herein by reference.

### TECHNICAL FIELD

The present disclosure relates to a drive unit and a method for manufacturing the drive unit.

### BACKGROUND

Previously, an electric vehicle having a maximum speed of 60 km/h or lower has been proposed. An unmanned transport vehicle has been proposed as an example of such an electric vehicle.

In order to rotate drive wheels of the electric vehicle, drive units are required. The drive unit includes: a shaft that applies a rotational drive force to the drive wheel; an electric motor; an inverter that is electrically connected to stator windings of the electric motor; and a housing that receives the electric motor and the inverter.

### SUMMARY

This section provides a general summary of the disclosure, and is not a comprehensive disclosure of its full scope or all of its features.

According to the present disclosure, there is provided a drive unit configured to be applied to an electric vehicle that includes a drive wheel and has a maximum speed of 60 km/h or lower. The drive unit may include a shaft, an electric motor, an inverter and a housing. The shaft may be configured to apply a rotational drive force to the drive wheel. The electric motor may include: a plurality of stator windings; and a rotor which is configured to rotate the shaft. The inverter may be electrically connected to the plurality of stator windings and may be configured to supply an electric current to the plurality of stator windings when a switching control operation of the inverter is executed. The housing may receive the electric motor and the inverter. The electric motor may be configured to operate as an electric power steering motor for electric power steering in a vehicle that is configured to travel on public roads.

### BRIEF DESCRIPTION OF DRAWINGS

The drawings described herein are for illustrative purposes only of selected embodiments and not all possible implementations, and are not intended to limit the scope of the present disclosure.

FIG. 1 is a side view of an unmanned transport vehicle according to a first embodiment.

FIG. 2 is a view showing an electric drive device, an electricity storage device, and the like of the unmanned transport vehicle as viewed from above.

FIG. 3 is a longitudinal cross-sectional view of a drive unit.

FIG. 4 is a cross-sectional view taken along line 4-4 in FIG. 3, showing an electric motor of the drive unit.

FIG. 5 is a diagram showing an electrical configuration of the unmanned transport vehicle.

FIG. 6 is a plan view of a portion of the drive unit.

FIG. 7 is a side view of the portion of the drive unit.

FIG. 8 is a plan view showing connections via cables, among the respective drive units, a voltage converter and a host ECU.

FIG. 9 is a side view of a portion of a drive unit according to a second embodiment.

FIG. 10 is a plan view showing connections via cables, among the respective drive units, the voltage converter and the host ECU.

FIG. 11 is a side view of a portion of a drive unit according to a third embodiment.

FIG. 12 is a plan view showing connections via cables, among the respective drive units, the voltage converter and the host ECU.

FIG. 13 is a plan view showing connections via cables, among the respective drive units, the voltage converter and the host ECU according to a fourth embodiment.

FIG. 14 is a plan view showing connections via cables, among the respective drive units, the voltage converter and the host ECU according to a fifth embodiment.

FIG. 15 is a view of the drive unit as seen from a center side in a vehicle width direction.

FIG. 16 is a diagram showing a spiral cable according to a sixth embodiment.

FIG. 17 is a cross-sectional view showing a transverse cross-section of a spiral cable.

FIG. 18 is a view showing an electric drive device, an electricity storage device, and the like of an unmanned transport vehicle according to a seventh embodiment, as viewed from above.

FIG. 19 is a diagram showing manufacturing steps of an electric drive device and the like according to an eighth embodiment.

### DETAILED DESCRIPTION

Previously, an electric vehicle having a maximum speed of 60 km/h or lower has been proposed. An unmanned transport vehicle has been proposed as an example of such an electric vehicle.

In order to rotate drive wheels of the electric vehicle, drive units are required. The drive unit includes: a shaft that applies a rotational drive force to the drive wheel; an electric motor; an inverter that is electrically connected to stator windings of the electric motor; and a housing that receives the electric motor and the inverter. The electric vehicle described above may be exposed, for example, to vibrations caused by irregularities of the road surface, moisture, dust, and the like. Therefore, it is necessary to newly design and develop a highly reliable drive unit. However, in this case, there is a concern that a period required for design and development may be prolonged, and the cost associated with the design and development may increase.

According to the present disclosure, there is provided a drive unit configured to be applied to an electric vehicle that includes a drive wheel and has a maximum speed of 60 km/h or lower. The drive unit includes a shaft, an electric motor, an inverter and a housing. The shaft is configured to apply a rotational drive force to the drive wheel. The electric motor includes: a plurality of stator windings; and a rotor which is configured to rotate the shaft. The inverter is electrically connected to the plurality of stator windings and is configured to supply an electric current to the plurality of stator windings when a switching control operation of the inverter is executed. The housing receives the electric motor and the inverter. The electric motor is configured to operate as an electric power steering motor for electric power steering in a vehicle that is configured to travel on public roads.

According to the present disclosure, there is also provided a method for manufacturing the drive unit. The method includes: manufacturing the electric motor as one of a plurality of electric motors; supplying one or more of the plurality of electric motors as an electric power steering motor used for manufacturing of an electric power steering apparatus and supplying another one or more of the plurality of electric motors as the electric motor for manufacturing of the drive unit; and manufacturing the drive unit using the electric motor supplied as the electric motor for manufacturing of the drive unit.

According to the present disclosure, the electric power steering motor for the electric power steering in the vehicle configured to travel on the public roads is used as the electric motor of the drive unit. As a result, it is possible to provide the highly reliable drive unit while suppressing prolongation of the design and development period and an increase in cost.

Hereinafter, embodiments will be described with reference to the drawings. In the following embodiments, functionally and/or structurally corresponding parts and/or associated parts may be denoted by the same reference signs or by reference signs that differ in hundreds digit. With respect to corresponding parts and/or associated parts, reference may be made to the explanations provided in other embodiments.

### First Embodiment

Hereinafter, a first embodiment embodying an electric drive device according to the present disclosure will be described with reference to the drawings. The electric drive device is applied to a compact mobility. The compact mobility of the present embodiment is a vehicle that travels at a low speed, for example, at a traveling speed (specifically, a maximum traveling speed) of 10 km/h or lower, and specifically, is an unmanned transport vehicle (specifically, an automatic guided vehicle (AGV) in this instance) that is an electric vehicle used in a factory.

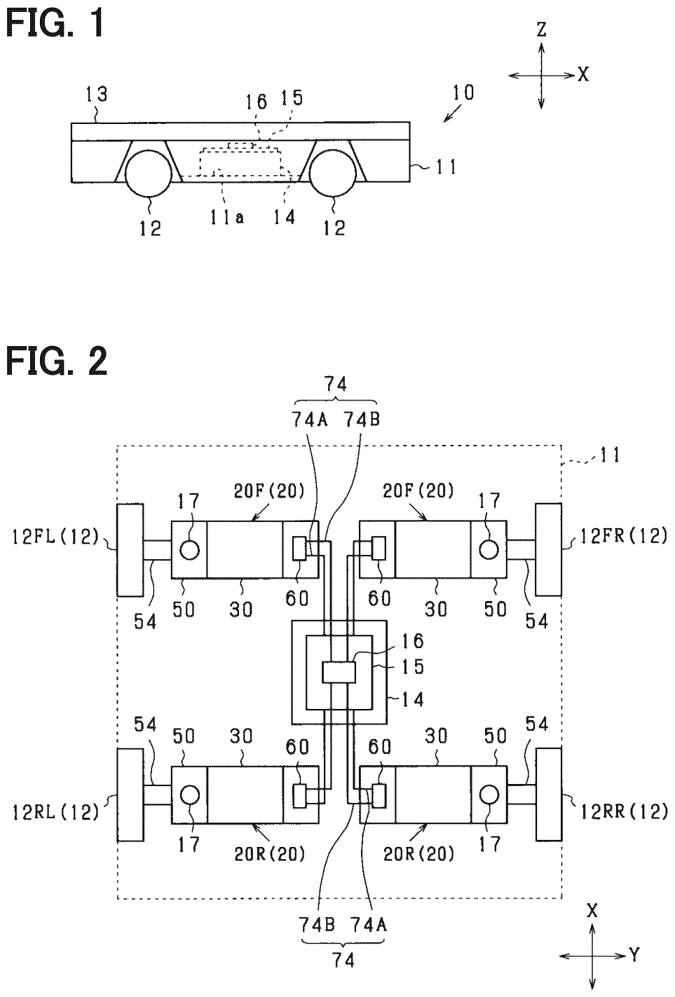

As shown in FIGS. 1 and 2, the unmanned transport vehicle 10 includes a vehicle body 11 and a plurality of drive wheels 12. In the present embodiment, the plurality of drive wheels 12 include a left front drive wheel 12FL, a right front drive wheel 12FR, a left rear drive wheel 12RL and a right rear drive wheel 12RR. A rotational center axis of each drive wheel 12FL, 12FR, 12RL, 12RR extends in a vehicle width direction Y of the unmanned transport vehicle 10 in a case where a steering angle of a steering mechanism 17, which will be described later, is 0 degrees.

An upper portion of the vehicle body 11 serves as a load-carrying portion 13 on which an object to be transported is placed. Each drive wheel 12FL, 12FR, 12RL, 12RR is positioned below the load-carrying portion 13.

The vehicle body 11 has: the electric drive device for driving the unmanned transport vehicle 10; an electricity storage device 14, which serves as a direct current (DC) power source that is an electric power supply source for the electric drive device; a voltage converter 15; and a host ECU 16. The electricity storage device 14 is, for example, a secondary battery such as a lithium-ion battery, a nickel-metal hydride battery, or a lead-acid battery. A rated voltage of the electricity storage device 14 is, for example, 12 V, 24 V, or 48 V. Note that the electricity storage device 14 may be, for example, a fuel cell.

In the vehicle body 11, a device mounting portion 11a, which extends in the vehicle width direction Y and a vehicle length direction X of the unmanned transport vehicle 10, is provided on the lower side of the load-carrying portion 13. An upper surface of the device mounting portion 11a is located, for example, below the rotational center axes of the drive wheels 12FL, 12FR, 12RL, 12RR in an up-down direction Z of the unmanned transport vehicle 10. The electricity storage device 14 is provided on the device mounting portion 11a. Specifically, in a plan view of the vehicle body 11, the electricity storage device 14 is provided on a center portion of the device mounting portion 11a, which is centered in the vehicle length direction X and the vehicle width direction Y. In the present embodiment, the voltage converter 15 is provided above the electricity storage device 14, and the host ECU 16 is provided above the voltage converter 15. The electricity storage device 14 is placed between the front drive wheels 12FL, 12FR and the rear drive wheels 12RL, 12RR in the vehicle length direction X.

The electric drive device includes a plurality of drive units 20 that are respectively provided to the drive wheels 12FL, 12FR, 12RL, 12RR. Each drive unit 20 has a shape that extends in the vehicle width direction Y, and in the present embodiment, has a cylindrical cross section. The drive units 20 of the present embodiment have the same configuration. The drive units 20 for rotating the front drive wheels (also referred to as front-side drive wheels) 12FL, 12FR are referred to as “front-side units 20F,” and the drive units 20 for rotating the rear drive wheels (also referred to as rear-side drive wheels) 12RL, 12RR are referred to as “rear-side units 20R.” Here, each front-side unit 20F is arranged alongside the corresponding front drive wheel 12FL, 12FR in the vehicle width direction Y, and each rear-side unit 20R is arranged alongside the corresponding rear drive wheel 12RL, 12RR in the vehicle width direction Y. The drive units 20 for rotating the left drive wheels (also referred to as left-side drive wheels) 12FL, 12RL are referred to as “left-side units,” and the drive units 20 for rotating the right drive wheels (also referred to as right-side drive wheels) 12FR, 12RR are referred to as “right-side units.” Here, each left-side unit is arranged alongside the corresponding left drive wheel 12FL, 12RL in the vehicle width direction Y, and each right-side unit is arranged alongside the corresponding left-side unit and the corresponding right-side drive wheel 12FR, 12RR in the vehicle width direction Y.

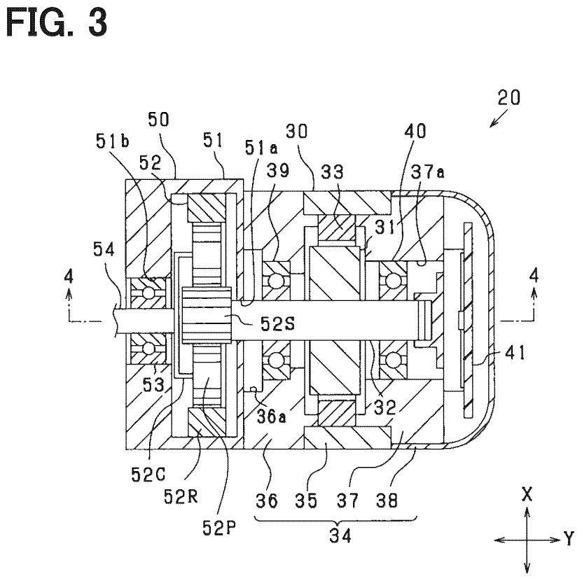

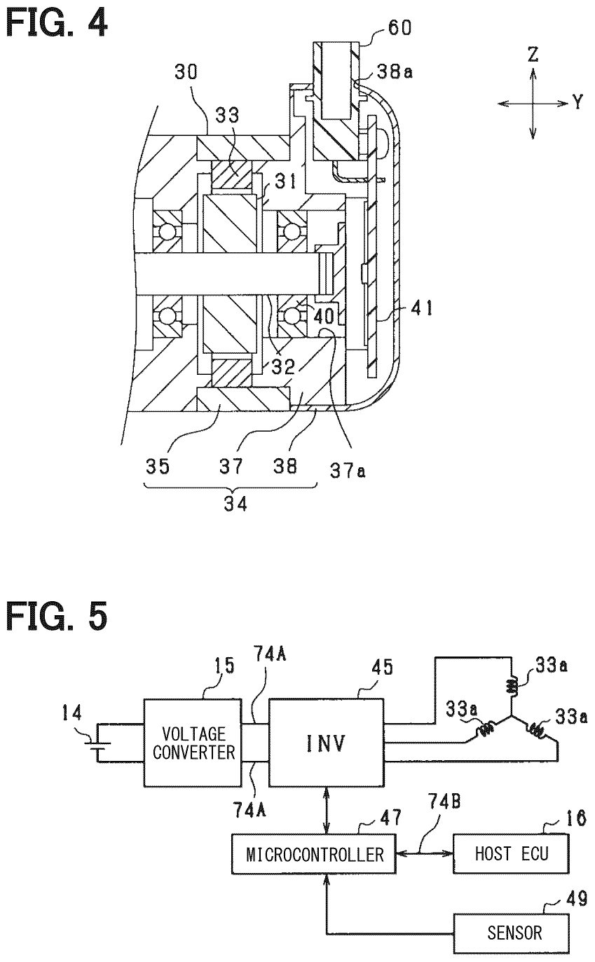

Each drive unit 20 includes an electric motor 30. The drive unit 20 will be described with reference to FIGS. 3 and 4. FIG. 3 is a longitudinal cross-sectional view of the drive unit 20 that rotates the left front drive wheel 12FL, and FIG. 4 is a cross-sectional view taken along line 4-4 in FIG. 3, showing the electric motor 30.

The electric motor 30 includes: a rotor 31 which has a plurality of field magnetic poles (e.g., a plurality of permanent magnets); a motor shaft 32 which is fixed to the rotor 31; and a stator 33 which is placed on a radially outer side of the rotor 31 and is radially opposed to the rotor 31. A rotational center axis of the motor shaft 32 extends in a horizontal direction. The stator 33 includes: a stator core (not shown); and a plurality of stator windings 33a (see FIG. 5) which are wound around the stator core. Here, a rated output (output capacity) of the electric motor 30 is, for example, 400 to 700 W.

The electric motor 30 includes a motor housing 34. The motor housing 34 includes a tubular portion 35, a first connecting portion 36, a second connecting portion 37 and a cover portion 38. The tubular portion 35 is shaped in a long tubular form extending in an extending direction of the motor shaft 32, and specifically, the tubular portion 35 is shaped in a cylindrical tubular form. The first connecting portion 36 is coupled to a first end part of the tubular portion 35 facing in a longitudinal direction of the tubular portion 35, and the second connecting portion 37 is coupled to a second end part of the tubular portion 35 facing in the longitudinal direction. The rotor 31 and the stator 33 are received in a cylindrical space surrounded by the tubular portion 35, the first connecting portion 36 and the second connecting portion 37. The stator 33 is fixed to an inner peripheral surface of the tubular portion 35. Here, the motor housing 34 is not limited to having a cylindrical cross section, and may have, for example, a rectangular cross section.

The first connecting portion 36 has a first opening 36a. A first bearing 39 is installed in the first opening 36a. Furthermore, the second connecting portion 37 has a second opening 37a, and a second bearing 40 is installed in the second opening 37a. In the present embodiment, each bearing 39, 40 is a rolling bearing having an inner race, an outer race, and a plurality of rolling elements held between the inner race and the outer race. A first end portion of the motor shaft 32 is rotatably supported by the first bearing 39, and a second end portion of the motor shaft 32 is rotatably supported by the second bearing 40.

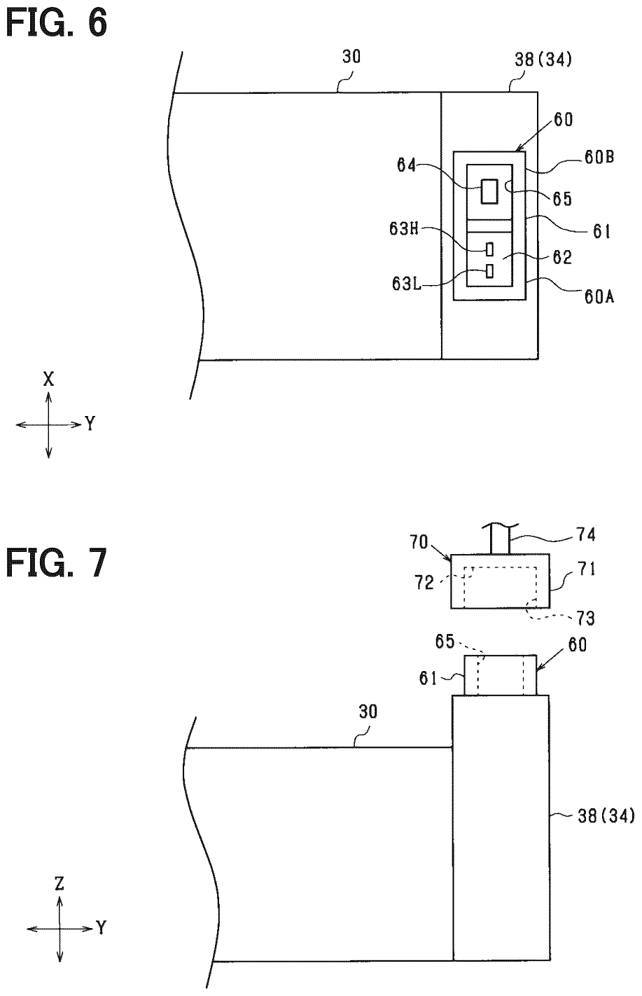

The cover portion 38 is installed to a part of the second connecting portion 37 which is opposite to the tubular portion 35 in a longitudinal direction of the motor housing 34. A control circuit board 41 is installed in a space surrounded by the second connecting portion 37 and the cover portion 38. In the present embodiment, the control circuit board 41 is arranged such that a plate surface of the control circuit board 41 is perpendicular to the extending direction of the motor shaft 32. An inverter 45 (see FIG. 5), which will be described later, is installed on the control circuit board 41. As shown in FIG. 4, an opening 38a is formed in the cover portion 38. A receptacle 60, which is electrically connected to the control circuit board 41, is inserted through the opening 38a. The receptacle 60 includes an electric power receptacle 60A and a communication receptacle 60B (see FIG. 6).

Each drive unit 20 includes a speed reducer 50. The speed reducer 50 amplifies an input torque received from the motor shaft 32 of the electric motor 30 and outputs it. The speed reducer 50 includes a housing 51 coupled to the first connecting portion 36. A planetary gear mechanism 52 is received in the housing 51. The planetary gear mechanism 52 includes: a sun gear 52S, which is fixed to the motor shaft 32; a plurality of planetary gears 52P, which are meshed with the sun gear 52S; a ring gear 52R, which is meshed with the planetary gears 52P; and a planetary carrier 52C, which rotatably supports the planetary gears 52P. The rotational center axis of the sun gear 52S is the same as the rotational center axis of a shaft of the planetary carrier 52C.

The sun gear 52S is an externally toothed gear and is fixed to the motor shaft 32 inserted through a first opening 51a of the housing 51 to rotate integrally with the motor shaft 32. The ring gear 52R is an internally toothed gear shaped in a ring form and is fixed to an inner peripheral surface of the housing 51. The planetary gear 52P is an externally toothed gear and is rotatably supported on the shaft of the planetary carrier 52C via a rolling bearing.

A second opening 51b is formed in the housing 51, and a bearing 53 (rolling bearing) is installed in the second opening 51b. The bearing 53 rotatably supports a shaft 54, which serves as an output shaft of the planetary carrier 52C. The drive wheel 12 is coupled to the shaft 54. Note that the speed reducer mechanism received in the housing 51 may be, for example, a cycloidal gear mechanism.

As shown in FIG. 2, the unmanned transport vehicle 10 includes the steering mechanism 17 that is configured to steer the drive wheel 12. The steering mechanism 17 is individually provided for each drive unit 20 and couples between the drive unit 20 and the vehicle body 11 (thereby couples between the drive wheel 12 and the vehicle body 11). The steering mechanism 17 rotatably supports the drive unit 20 with respect to the vehicle body 11 around a steering center axis that extends in the up-down direction Z. In the present embodiment, the steering mechanism 17 is mounted on an upper portion of the housing 51, which is part of the speed reducer 50.

Next, the electrical configuration of the unmanned transport vehicle 10 will be described with reference to FIG. 5.

The voltage converter 15 is a DC-DC converter that converts the DC voltage, which is outputted from the electricity storage device 14, to a different voltage level and supplies it to the inverter 45. The voltage converter 15 is controlled by the host ECU 16. An output portion of the voltage converter 15 and an input portion of the inverter 45 are electrically connected to each other by an electric power cable 74A, which will be described later. For example, in a case where the electric motor 30 and the inverter 45 have a rated voltage of 12 V, and the electricity storage device 14 has a rated voltage of 48 V, the voltage converter 15 steps down the DC voltage outputted from the electricity storage device 14 and supplies it to the inverter 45. Furthermore, in another case where the electric motor 30 and the inverter 45 have a rated voltage of 24 V, and the electricity storage device 14 has a rated voltage of 12 V, the voltage converter 15 steps up the DC voltage outputted from the electricity storage device 14 and supplies it to the inverter 45. In the present embodiment, the voltage converter 15 and the electricity storage device 14 serve as a direct current power source.

The control circuit board 41 of each drive unit 20 has the inverter 45 and a microcontroller 47. The inverter 45 includes semiconductor switches for upper and lower arms for three phases. The inverter 45 converts the DC electric power supplied from the voltage converter 15 into AC electric power through a switching control operation of the semiconductor switches of the upper and lower arms and supplies the AC power to the stator windings 33a. That is, the inverter 45 is configured to supply the electric current to the stator windings 33a when the switching control operation of the inverter 45 is executed.

Each drive unit 20 includes a sensor 49. The sensor 49 is used in a drive control operation of the electric motor 30. The sensor 49 includes an electric current sensor and a rotational angle sensor. The electric current sensor detects an electric current (phase current) flowing through the stator windings 33a. The rotational angle sensor detects a rotational angular position (electrical angle) of the rotor 31. Measurement values of the sensor 49 are inputted to the microcontroller 47. In the present embodiment, the electric current sensor and the rotational angle sensor are received in the motor housing 34. The electric motor 30 of the present embodiment is an electric motor of an integrated electromechanical type (also known as an integrated electromechanical motor) in which the rotor 31, the stator 33, the control circuit board 41 and the sensor 49 are received in the motor housing 34.

The microcontroller 47 performs the switching control operation of the inverter 45 to control a control amount of the electric motor 30 to a command value based on each detected value. The control amount is, for example, torque or a rotational speed of the rotor 31.

The microcontroller 47 of each drive unit 20 communicates with the host ECU 16 provided in the unmanned transport vehicle 10 via the communication receptacle 60B that constitutes part of the receptacle 60, for example, through CAN communication. The host ECU 16 includes a microcontroller as its major component. The host ECU 16 transmits the command value to the microcontroller 47 of each drive unit 20 via the communication receptacle 60B, so as to execute a desired control operation, such as a travel control operation, of the unmanned transport vehicle 10.

When the host ECU 16 determines that straight travel of the unmanned transport vehicle 10 is instructed, the host ECU 16 transmits a rotational speed command value to the microcontroller 47 of each drive unit 20 in order to perform the drive control operation of the electric motors 30 such that the left drive wheels 12FL, 12RL and the right drive wheels 12FR, 12RR are rotationally driven in the same direction at the same rotational speed.

When the host ECU 16 determines that braking of the unmanned transport vehicle 10 is instructed, the host ECU 16 transmits a torque command value to the microcontroller 47 of each drive unit 20 so as to generate braking torque in each electric motor 30. Therefore, a braking force is applied to the unmanned transport vehicle 10, and the unmanned transport vehicle 10 then stops.

When the host ECU 16 determines that turning travel of the unmanned transport vehicle 10 is instructed, the host ECU 16 transmits a rotational speed command value to the microcontroller 47 of each drive unit 20 in order to perform the drive control operation of the electric motors 30 such that all of the drive wheels 12FL, 12RL, 12FR, 2RR rotate in the same direction, and the rotational speed of the drive wheels on the turning side (either the left drive wheels 12FL, 12RL or the right drive wheels 12FR, 12RR) is lower than that of the remaining drive wheels.

Note that the host ECU 16 can also transmit the rotational speed command value to each microcontroller 47 so as to rotate the left drive wheels 12FL, 12RL and the right drive wheels 12FR, 12RR in opposite directions. In this case, the unmanned transport vehicle 10 makes a spin turn.

The functions provided by the microcontroller 47 and the microcontroller of the host ECU 16 can be provided by: software recorded in a tangible memory device; a computer, which executes the software; software alone; hardware alone, or by a combination thereof. For example, in a case where the microcontroller is implemented by an electronic circuit, which is the hardware, the functions can be provided by a digital circuit including a large number of logic circuits, or by an analog circuit. For example, the microcontroller executes a program stored in a non-transitory tangible storage medium serving as its storage device. When the program is executed, a method corresponding to the program is carried out. The storage device is, for example, a non-volatile memory. Note that the program stored in the storage device can be updated via a network such as the Internet, for example, through over-the-air (OTA) updates.

The electric motor 30 of the present embodiment is configured to operate as an electric power steering motor for electric power steering in a vehicle that is configured to travel on public roads (specifically, a passenger car). Specifically, the electric motor 30 (i.e., the portion of the drive unit 20 other than the speed reducer 50) of the integrated electromechanical type, which includes: the control circuit board 41 having the inverter 45 and the microcontroller 47; and the sensor 49, is identical to the electric motor of the integrated electromechanical type of the electric power steering apparatus. The electric motor 30 of the integrated electromechanical type has the same external appearance as the electric power steering motor. The vehicle, which is configured to travel on the public roads, refers to a vehicle that is capable of traveling on the public roads at a speed of 60 km/h or higher. The electric power steering apparatus is an apparatus that assists the driver's steering operation. By employing the electric power steering motor as the electric motor of the drive unit, it is possible to suppress an increase in a time period required for designing and developing the drive unit for the compact electric vehicle and an increase in the cost. In addition, since the highly reliable electric motor of the integrated electromechanical type designed for the electric power steering can be employed, it is possible to provide the highly reliable drive unit 20.

A plurality of main components of the electric motor 30 of the integrated electromechanical type used in the drive unit 20 are the same as a plurality of main components of the electric power steering motor. This makes it possible to enhance the reliability of the drive unit 20 while suppressing the cost of its design and development.

Here, the main components include a plurality of components that form a magnetic circuit of the electric motor 30, and specifically the main components include the permanent magnets of the rotor 31 and the stator core. Accordingly, the magnetic force of the permanent magnets in the electric motor 30 is the same as that of the permanent magnets in the electric power steering motor. In addition, shapes, dimensions, weights and materials of the stator core and the permanent magnets in the electric motor 30 are the same as those of the stator core and the permanent magnets in the electric power steering motor.

In addition, the main components include a plurality of components that form an electrical circuit configured to perform the drive control operation of the electric motor 30, and specifically the main components include the inverter 45, the microcontroller 47 and the sensor 49.

The electric motor 30 of the drive unit 20 has the same output capacity (for example, rated output) as the electric power steering motor.

Next, with reference to FIGS. 6 to 8, a configuration for electrically connecting the voltage converter 15 to the inverter 45 of each drive unit 20, and a configuration for communicably connecting the host ECU 16 to the microcontroller 47 of each drive unit 20 will be described.

The receptacle 60, which projects from the motor housing 34, is provided on the motor housing 34. The receptacle 60 includes: a bottom plate 62 which is provided with terminals; and a peripheral wall 61 which extends from an outer periphery of the bottom plate 62. An opening at one end of the peripheral wall 61 forms a receptacle opening 65. In the present embodiment, the receptacle 60 is provided on an upper portion of the motor housing 34 in a state where the receptacle opening 65 faces upward. Specifically, the receptacle 60 is provided on an end portion (i.e., the cover portion 38) of the motor housing 34, which faces toward the center between the drive units 20 in the vehicle width direction Y. More specifically, the receptacle 60 is provided on an upper portion of the end portion of the motor housing 34 (see FIG. 4). With this configuration, lengths of the cables 74 are reduced.

The bottom plate 62 has a positive terminal 63H, a ground terminal 63L and a communication terminal 64, which serve as the terminals. In the present embodiment, the communication terminal 64, the positive terminal 63H and the ground terminal 63L are arranged in this order from the front side in the vehicle length direction X. The communication terminal 64 is electrically connected to the microcontroller 47.

The positive terminal 63H is electrically connected to a high-potential-side input portion (or simply referred to as a high-potential side) of the inverter 45, and the ground terminal 63L is electrically connected to a low-potential-side input portion (or simply referred to as a low-potential side) of the inverter 45. Specifically, the high-potential-side input portion of the inverter 45 is formed by high-potential-side terminals of the upper arm switches of the inverter 45, and the low-potential-side input portion of the inverter 45 is formed by low-potential-side terminals of the lower arm switches of the inverter 45. For example, in a case where the upper and lower arm switches are N-channel MOSFETs, the high-potential-side terminal of each switch is a drain, and the low-potential-side terminal is a source.

A portion of the receptacle 60, which corresponds to the positive terminal 63H and the ground terminal 63L, is the electric power receptacle 60A, and a portion of the receptacle 60, which corresponds to the communication terminal 64, is the communication receptacle 60B. That is, the receptacle 60 of the present embodiment has the electric power receptacle 60A and the communication receptacle 60B which are integrated together.

A first end of each electric power cable 74A is electrically connected to the output portion of the voltage converter 15. Specifically, each electric power cable 74A, which corresponds to the receptacle 60 of the corresponding front-side unit 20F, extends from a side surface of the voltage converter 15, which faces the front side in the vehicle length direction X, and each electric power cable 74A, which corresponds to the receptacle 60 of the corresponding rear-side unit 20R, extends from a side surface of the voltage converter 15, which faces the rear side in the vehicle length direction X. Each electric power cable 74A includes: a high-potential-side cable, which electrically connects between a high-potential-side output portion of the voltage converter 15 and the high-potential-side input portion of the inverter 45; and a low-potential-side cable, which electrically connects between a low-potential-side output portion of the voltage converter 15 and the low-potential-side input portion of the inverter 45.

A first end of each communication cable 74B is electrically connected to the host ECU 16. Specifically, each communication cable 74B, which corresponds to the receptacle 60 of the corresponding front-side unit 20F, extends from a side surface of the host ECU 16, which faces the front side in the vehicle length direction X, and each communication cable 74B, which corresponds to the receptacle 60 of the corresponding rear-side unit 20R, extends from a side surface of the host ECU 16, which faces the rear side in the vehicle length direction X. In the present embodiment, the communication cables 74B and the electric power cables 74A are bundled together by a tube having electrical insulation properties, thereby forming the integrated cables 74. However, the tube is not essential.

At a second end of each of the cables 74, a plug 70, which is inserted into the corresponding receptacle 60, is provided. The receptacle 60 and the plug 70 form a connector. The plug 70 includes: a bottom plate 72, which has terminals; and a peripheral wall 71, which extends from an outer periphery of the bottom plate 72. An opening at one end of the peripheral wall 71 forms a plug opening 73. The bottom plate 72 has: a positive terminal, which is electrically connected to the high-potential-side cable; a ground terminal, which is electrically connected to the low-potential-side cable; and a communication terminal, which is electrically connected to the communication cable 74B.

When the plug 70 is inserted into the receptacle 60 in a state where the receptacle opening 65 and the plug opening 73 are opposed to each other, the positive terminal 63H of the receptacle 60 and the positive terminal of the plug 70 come into contact with each other, and the ground terminal 63L of the receptacle 60 and the ground terminal of the plug 70 come into contact with each other. As a result, the input portion of the inverter 45 and the output portion of the voltage converter 15 are electrically connected with each other via the electric power cable 74A. Furthermore, when the plug 70 is inserted into the receptacle 60, the communication terminal 64 of the receptacle 60 and the communication terminal of the plug 70 come into contact with each other. As a result, the microcontroller 47 and the host ECU 16 are electrically connected with each other via the communication cable 74B, and thereby the microcontroller 47 and the host ECU 16 can communicate with each other. Each cable 74 extends from the upper portion of the cover portion 38 toward the corresponding one of the voltage converter 15 and the host ECU 16.

The drive unit 20 is individually provided for each of the drive wheels 12. Each drive unit 20 includes the electric motor 30, the inverter 45 and the motor housing 34. In each drive unit 20, the electric motor 30 and the inverter 45 are received in the motor housing 34. Therefore, electrical wirings, which electrically connect the stator windings 33a of the electric motor 30 to the inverter 45, can be also received in the motor housing 34, and thereby the structure of the electric drive device can be simplified.

Furthermore, the receptacle 60, which is electrically connected to the inverter 45, is provided on the motor housing 34 of each drive unit 20, and the plug 70 of the cable 74 can be inserted into the receptacle 60. As a result, since the receptacle 60, the voltage converter 15 and the host ECU 16 can be electrically connected via the cables 74 for each drive unit 20, the configuration of the electric drive apparatus can be simplified.

In each drive unit 20, the receptacle 60 is provided on the upper portion of the motor housing 34 in the state where the receptacle opening 65 faces upward. As a result, even when the unmanned transport vehicle 10 receives vibrations while traveling, the receptacle 60 and the plug 70 are less likely to become disconnected. As a result, electric power supply from the electricity storage device 14 to each inverter 45 and communication between the host ECU 16 and each microcontroller 47 can be reliably maintained.

The receptacle 60 is provided on the upper portion of the motor housing 34 in the state where the receptacle opening 65 faces upward. Accordingly, a foreign object (e.g., dust and/or water) from the road surface, on which the unmanned transport vehicle 10 travels, is less likely to reach the receptacle 60 or the plug 70. Also, even when the foreign object reaches the receptacle 60 or the plug 70, the peripheral wall 61 of the receptacle 60 and the peripheral wall 71 of the plug 70, both extending in the up-down direction Z, can reliably prevent the foreign object from passing over the peripheral wall 61 of the receptacle 60 and reaching the terminals (e.g., the positive terminal 63H).

The electricity storage device 14, the voltage converter 15 and the host ECU 16 are placed at the center portion of the device mounting portion 11a of the vehicle body 11, which is centered in both the vehicle width direction Y and the vehicle length direction X. In this arrangement, each front-side unit 20F is placed on the front side of the electricity storage device 14 in the vehicle length direction X, and each rear-side unit 20R is placed on the rear side of the electricity storage device 14 in the vehicle length direction X. As a result, the length of each of the cables 74 extending from the four drive units 20 toward the electricity storage device 14 can be shortened, while also making the lengths of the respective cables 74 approximately equal to each other. Therefore, it is possible to equalize the impedance of the electrical paths connecting the voltage converter 15 and the respective inverters 45, and to equalize the impedance of the communication paths connecting the host ECU 16 and the respective microcontrollers 47. As a result, it is possible to reduce conduction loss in each electric power cable 74A and suppress communication timing deviation through each communication cable 74B.

### Second Embodiment

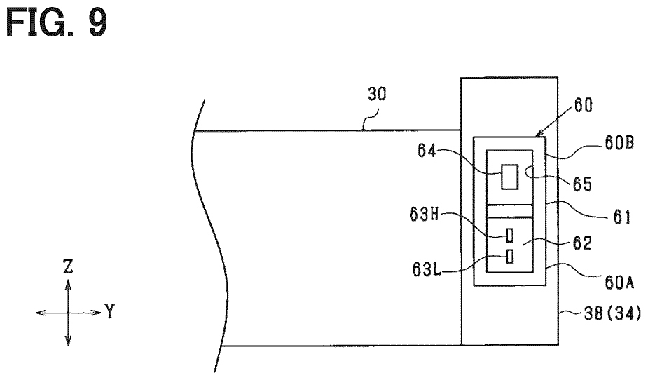

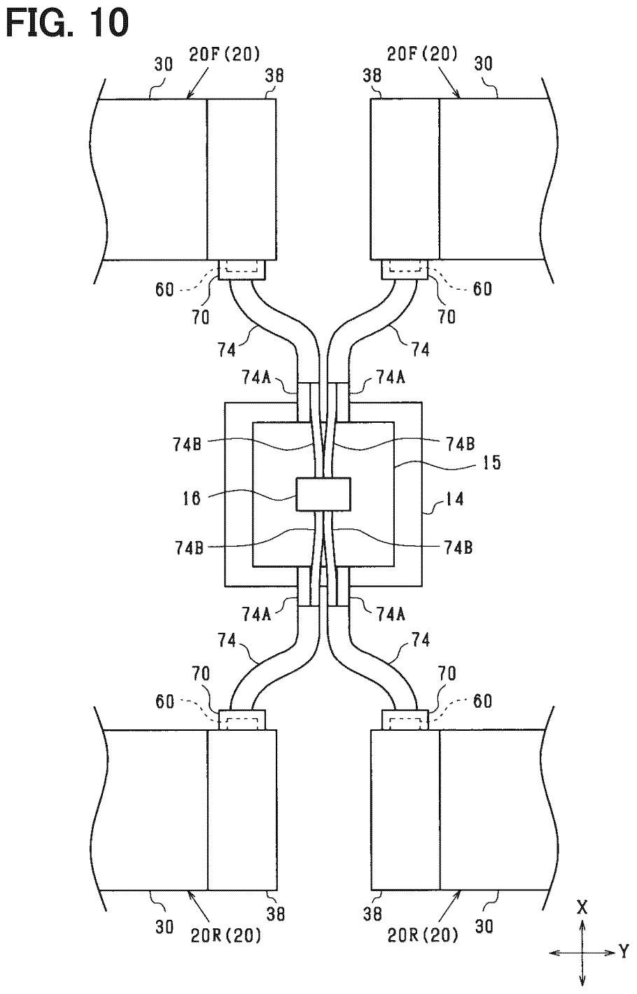

Hereafter, the second embodiment will be described with reference to the drawings, focusing on the differences from the first embodiment. In the present embodiment, as shown in FIGS. 9 and 10, in each drive unit 20, the receptacle 60 is provided on a side surface of the motor housing 34, which faces toward the electricity storage device 14 and the voltage converter 15 in the vehicle length direction X, in a state where the receptacle opening 65 faces toward the electricity storage device 14 and the voltage converter 15 in the vehicle length direction X. Specifically, in each front-side unit 20F, the receptacle 60 is provided on a side surface of the cover portion 38 (the cover portion 38 being part of the motor housing 34), which faces toward the rear-side unit 20R in the vehicle length direction X, in a state where the receptacle opening 65 faces toward the rear-side unit 20R in the vehicle length direction X. Furthermore, in each rear-side unit 20R, the receptacle 60 is provided on a side surface of the cover portion 38 which faces the front-side unit 20F in the vehicle length direction X, in a state where the receptacle opening 65 faces toward the front-side unit 20F in the vehicle length direction X.

According to the present embodiment described above, the length of each cable 74 can be reduced. This makes it possible to shorten the length of each electric power cable 74A to increase the effect of reducing conduction loss of each electric power cable 74A, and to suppress communication delay via each communication cable 74B.

In the present embodiment, in each of the front-side units 20F and each of the rear-side units 20R, the ground terminal 63L, the positive terminal 63H and the communication terminal 64 are arranged in the up-down direction Z in such a manner that the ground terminal 63L is positioned below the positive terminal 63H. By arranging the terminals 63H, 63L, 64 such that the ground terminal 63L, which has the smallest potential difference relative to the road surface on which the unmanned transport vehicle 10 travels, is positioned closest to the road surface, discharge from the electric power receptacle 60A to the road surface can be reliably limited.

### Third Embodiment

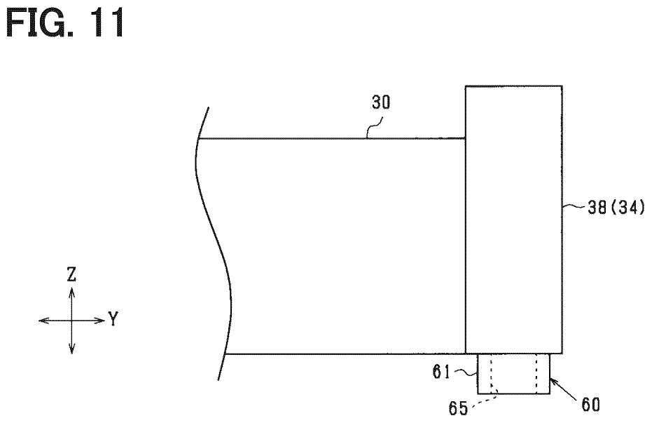

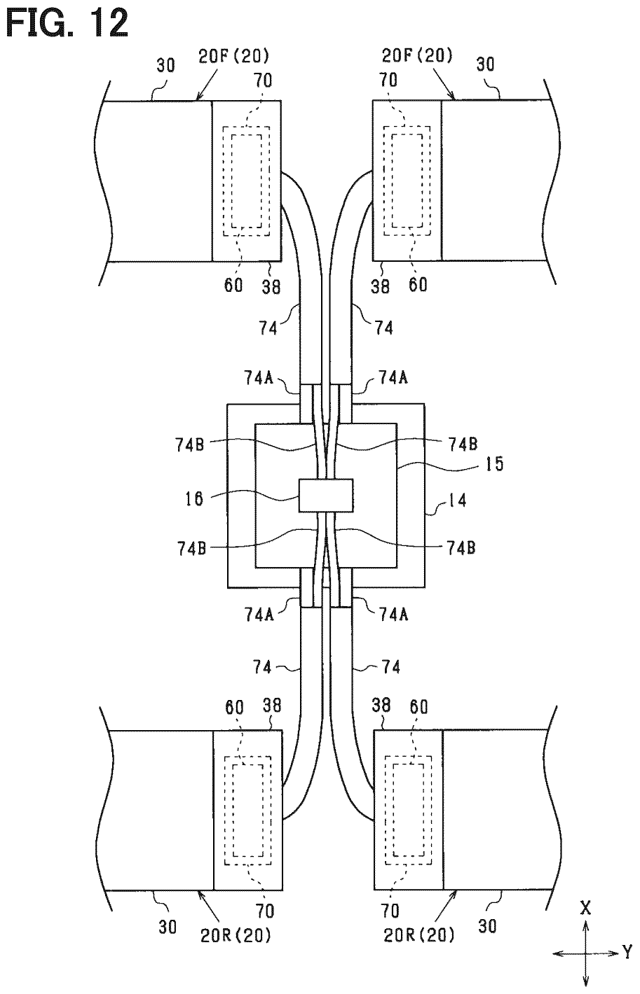

Hereafter, the third embodiment will be described with reference to the drawings, focusing on the differences from the first embodiment. In the present embodiment, as shown in FIGS. 11 and 12, in each drive unit 20, the receptacle 60 is provided on a lower portion of the cover portion 38, which forms part of the motor housing 34, in a state where the receptacle opening 65 faces downward.

According to the present embodiment described above, even in an environment where the unmanned transport vehicle 10 is exposed to water, it is possible to realize a structure in which water is less likely to enter through the gap between the peripheral wall 61 of the receptacle 60 and the peripheral wall 71 of the plug 70.

### Fourth Embodiment

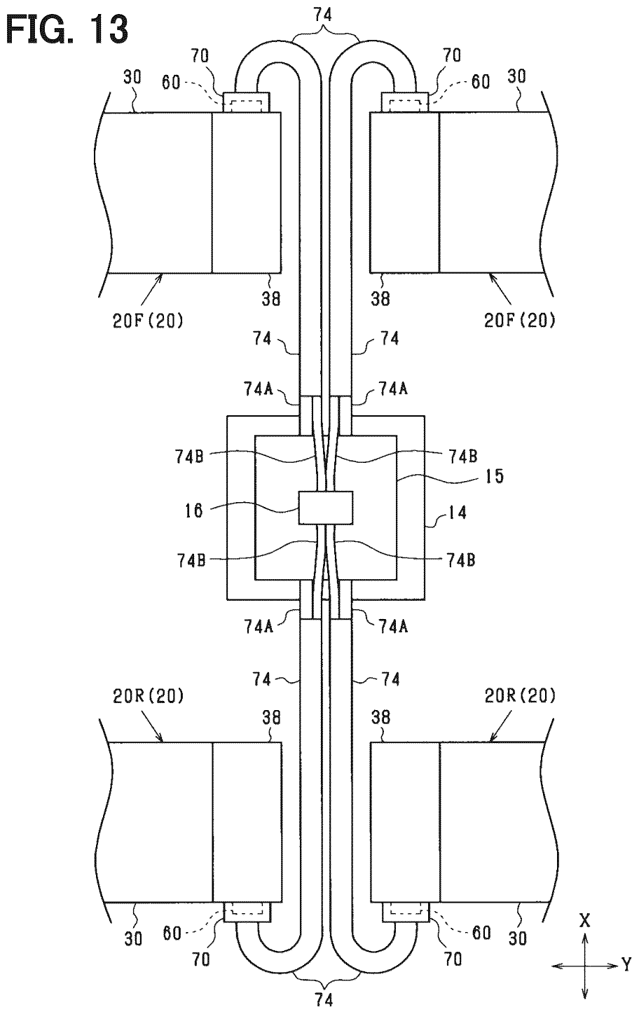

Hereafter, the fourth embodiment will be described with reference to the drawing, focusing on the differences from the first embodiment. In the present embodiment, as shown in FIG. 13, in each drive unit 20, the receptacle 60 is provided on a side surface of the motor housing 34, which faces away from the electricity storage device 14 and the voltage converter 15 in the vehicle length direction X, in a state where the receptacle opening 65 faces away from the electricity storage device 14 and the voltage converter 15 in the vehicle length direction X. Specifically, in each front-side unit 20F, the receptacle 60 is provided on a side surface of the cover portion 38 (the cover portion 38 being part of the motor housing 34), which faces away from the rear-side unit 20R in the vehicle length direction X, in a state where the receptacle opening 65 faces away from the rear-side unit 20R in the vehicle length direction X. Furthermore, in each rear-side unit 20R, the receptacle 60 is provided on a side surface of the cover portion 38 which faces away from the front-side unit 20F in the vehicle length direction X, in a state where the receptacle opening 65 faces away from the front-side unit 20F in the vehicle length direction X.

According to the present embodiment described above, the connecting and disconnecting operations of the plug 70 with respect to the receptacle 60 can be easily performed.

### Fifth Embodiment

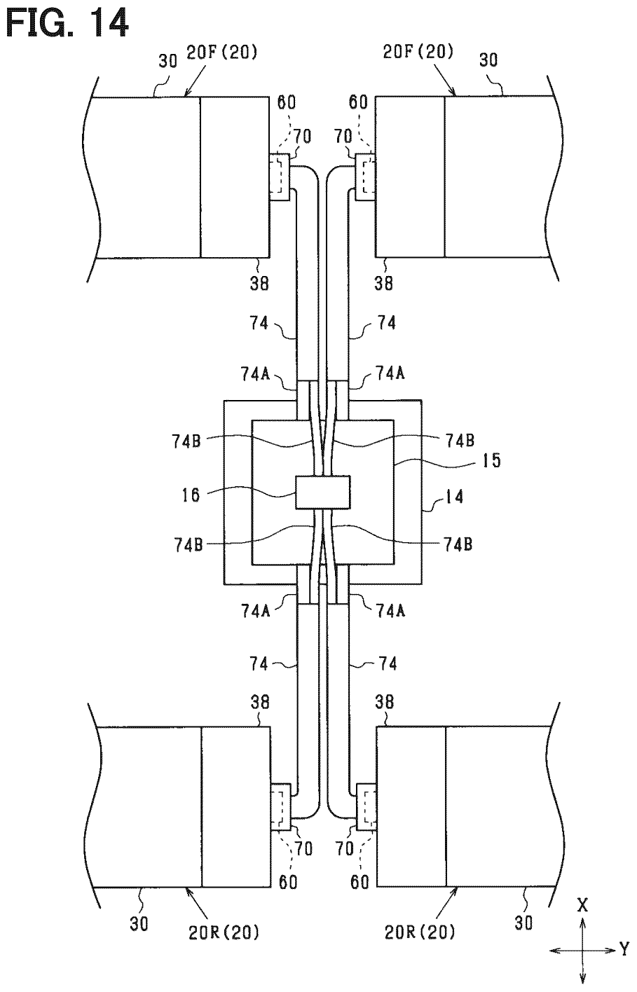

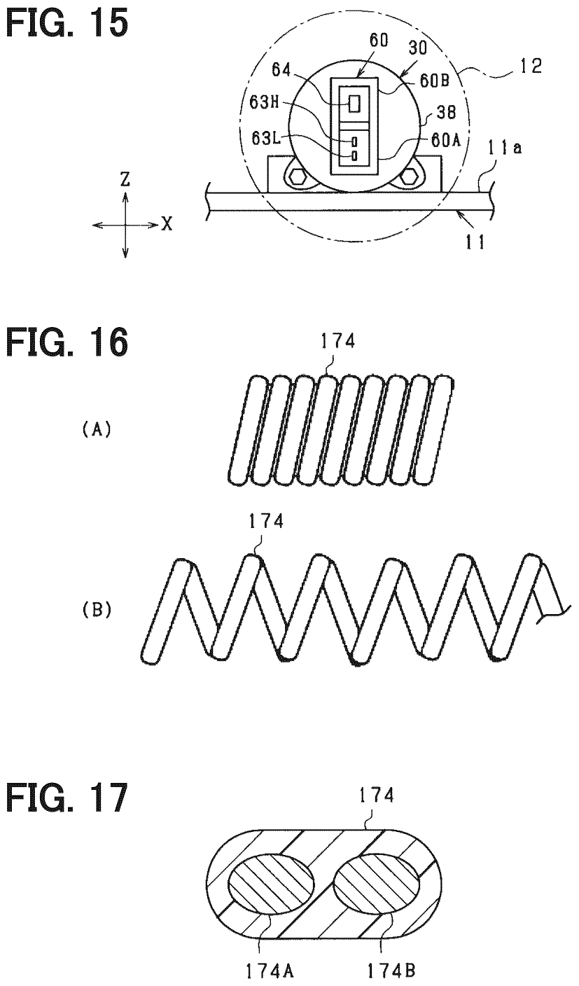

Hereafter, the fifth embodiment will be described with reference to the drawings, focusing on the differences from the first embodiment. In the present embodiment, as shown in FIGS. 14 and 15, in each drive unit 20, the receptacle 60 is provided on a side surface of the motor housing 34 (more specifically, the side surface of the end portion of the motor housing 34), which faces toward the center between the drive units 20 in the vehicle width direction Y, in a state where the receptacle opening 65 faces toward the center in the vehicle width direction Y. As a result, the receptacles 60 of the two front-side units 20F are opposed to each other in the vehicle width direction Y, and the receptacles 60 of the two rear-side units 20R are also opposed to each other in the vehicle width direction Y.

Furthermore, as shown in FIG. 15, the electric power receptacle 60A and the communication receptacle 60B are arranged one after another in the up-down direction Z. As a result, compared to a configuration in which the electric power receptacle 60A and the communication receptacle 60B are arranged one after another in the vehicle length direction X, a portion of the cable 74 near the plug 70 can be more easily bent toward the voltage converter 15, thereby improving the workability of the routing operation of the cable 74. It should be noted that, in FIG. 15, the shape of the cover portion 38 is simplified and illustrated as having a circular outer shape.

Furthermore, according to the present embodiment, as shown in FIG. 15, when the cover portion 38 is viewed from the center side in the vehicle width direction Y, the receptacle 60 does not protrude from the cover portion 38. Therefore, the dimensions of the drive unit 20 can be reduced.

### Sixth Embodiment

Hereafter, the sixth embodiment will be described with reference to the drawings, focusing on the differences from the first to fifth embodiments. In the present embodiment, as shown in FIG. 16, a spiral cable 174 is used as the cable connected to the receptacle 60 of each drive unit 20. The spiral cable 174 is formed in a helical shape and is configured to be extendable and contractible. Here, (A) of FIG. 16 shows the spiral cable 174 in an unextended state (i.e., a contracted state), and (B) of FIG. 16 shows the spiral cable 174 in an extended state. As shown in FIG. 17, the spiral cable 174 includes an electric power cable 174A and a communication cable 174B.

According to the present embodiment described above, when the drive wheel 12 is steered by the steering mechanism 17, the spiral cable 174 expands and contracts, thereby preventing entanglement or twisting of the spiral cable 174.

### Seventh Embodiment

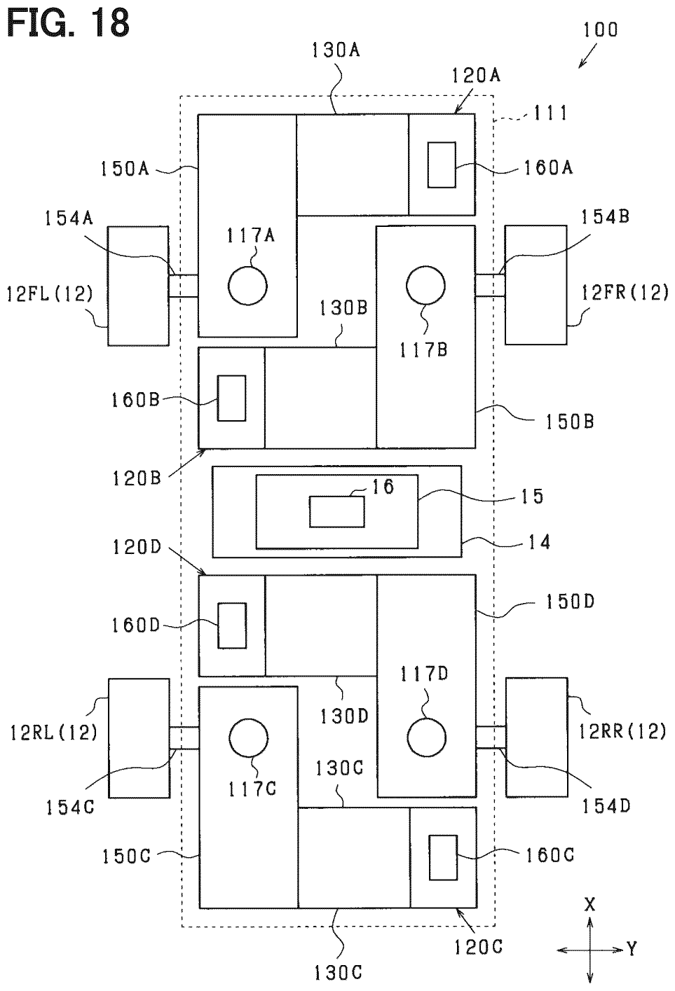

Hereafter, the seventh embodiment will be described with reference to the drawing, focusing on the differences from the first embodiment. As shown in FIG. 18, in the unmanned transport vehicle 110 of the present embodiment, the structure of the speed reducer provided in each drive unit is modified. Specifically, the vehicle body 111 of the unmanned transport vehicle 110 has a first drive unit 120A, a second drive unit 120B, a third drive unit 120C and a fourth drive unit 120D as the drive units.

The first drive unit 120A is a unit configured to rotate the left front drive wheel 12FL, and the second drive unit 120B is a unit configured to rotate the right front drive wheel 12FR. The third drive unit 120C is a unit configured to rotate the left rear drive wheel 12RL, and the fourth drive unit 120D is a unit configured to rotate the right rear drive wheel 12RR.

First of all, the drive units for the front wheels will be described.

The first drive unit 120A includes a first electric motor 130A and a first speed reducer 150A. The configuration of the first electric motor 130A is the same as that of the electric motor 30 of the first embodiment. A first receptacle 160A is provided on the upper portion of the motor housing (specifically, the cover portion) of the first electric motor 130A.

The first speed reducer 150A has an elongated shape that is elongated in the vehicle length direction X. Specifically, the first speed reducer 150A extends in the vehicle length direction X from an end portion of the motor housing of the first electric motor 130A, which faces in the vehicle width direction Y. The first speed reducer 150A of the present embodiment is a device that includes a plurality of spur gears. The shaft of the first electric motor 130A is fixed to one of the spur gears, which is provided at the input side. A first shaft 154A is fixed to another one of the spur gears, which is provided at the output side. The left front drive wheel 12FL is coupled to the first shaft 154A.

The second drive unit 120B includes a second electric motor 130B and a second speed reducer 150B and has the same configuration as the first drive unit 120A. A second receptacle 160B is provided on the upper portion of the motor housing (specifically, the cover portion) of the second electric motor 130B, and the second speed reducer 150B includes a second shaft 154B to which the right front drive wheel 12FR is coupled.

A rear-side portion of the first speed reducer 150A, which faces the rear side in the vehicle length direction X, and a front-side portion of the second speed reducer 150B, which faces the front side in the vehicle length direction X, are opposed to each other in the vehicle width direction Y. Furthermore, the rear-side portion of the first speed reducer 150A, which faces the rear side in the vehicle length direction X, and a left-side portion of the motor housing of the second electric motor 130B, which faces the left side in the vehicle width direction Y, are opposed to each other in the vehicle length direction X. In addition, the front-side portion of the second speed reducer 150B, which faces the front side in the vehicle length direction X, and a right-side portion of the motor housing of the first electric motor 130A, which faces the right side in the vehicle width direction Y, are opposed to each other in the vehicle length direction X. The above configuration implements the structure that has the reduced size in the vehicle width direction Y.

Next, the drive units for the rear wheels will be described.

The third drive unit 120C includes a third electric motor 130C and a third speed reducer 150C. The configuration of the third electric motor 130C is the same as that of the electric motor 30 of the first embodiment. A third receptacle 160C is provided on the upper portion of the motor housing (specifically, the cover portion) of the third electric motor 130C. The configuration of the third speed reducer 150C is basically the same as that of the first speed reducer 150A. The third speed reducer 150C includes a third shaft 154C to which the left rear drive wheel 12RL is coupled.

The fourth drive unit 120D includes a fourth electric motor 130D and a fourth speed reducer 150D and has the same configuration as the third drive unit 120C. A fourth receptacle 160D is provided on the upper portion of the motor housing (specifically, the cover portion) of the fourth electric motor 130D, and the fourth speed reducer 150D includes a fourth shaft 154D to which the right rear drive wheel 12RR is coupled.

A front-side portion of the third speed reducer 150C, which faces the front side in the vehicle length direction X, and a rear-side portion of the fourth speed reducer 150D, which faces the rear side in the vehicle length direction X, are opposed to each other in the vehicle width direction Y. In addition, the front-side portion of the third speed reducer 150C, which faces the front side in the vehicle length direction X, and a left-side portion of the motor housing of the fourth electric motor 130D, which faces the left side in the vehicle width direction Y, are opposed to each other in the vehicle length direction X. Furthermore, the rear-side portion of the fourth speed reducer 150D, which faces the rear side in the vehicle length direction X, and a right-side portion of the motor housing of the third electric motor 130C, which faces the right side in the vehicle width direction Y, are opposed to each other in the vehicle length direction X. The above configuration implements the structure that has the reduced size in the vehicle width direction Y.

Here, it should be noted that, in the housings of the first and fourth speed reducers 150A, 150D, first and fourth steering mechanisms 117A, 117D, each of which is the same as the steering mechanism 17 of the first embodiment, are mounted on rear portions of these housings, which face the rear side in the vehicle length direction X (specifically, on portions corresponding to the first and fourth shafts 154A, 154D, respectively). Furthermore, in the housings of the second and third speed reducers 150B, 150C, second and third steering mechanisms 117B, 117C, each of which is the same as the steering mechanism 17 of the first embodiment, are mounted on front portions of these housings, which face the front side in the vehicle length direction X (specifically, on portions corresponding to the second and third shafts 154B, 154C, respectively). In FIG. 18, cables, which connect the receptacles 60A, 60B, 60C, 60D to the voltage converter 15 and the host ECU 16, are omitted from illustration.

According to the present embodiment described above, the advantages, which are the same as those of the first embodiment, can be achieved.

### Eighth Embodiment

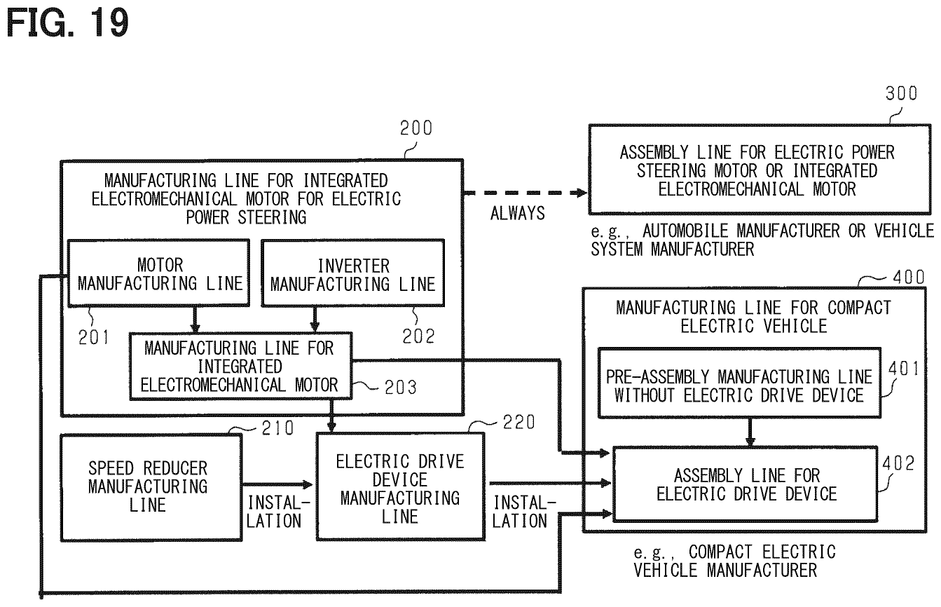

Hereafter, the eighth embodiment will be described with reference to the drawing, focusing on the differences from the first embodiment. In the present embodiment, a method for manufacturing the electric drive device and the compact electric vehicle (specifically, the unmanned transport vehicle), which includes the electric drive device, will be described. Hereinafter, a manufacturing process will be described with reference to FIG. 19.

Step 200 is a step of manufacturing the electric motor for the electric power steering apparatus of the vehicle. The electric motor, which is manufactured in step 200, has the same configuration as that of the electric motor 30 shown in FIGS. 3 and 4.

Specifically, in step 201, portions of the electric motor, which are other than the electrical components, such as the control circuit board 41 shown in FIG. 4, are manufactured. Specifically, in step 202, the electrical components, such as the control circuit board 41, of the electric motor are manufactured. As described above, the control circuit board 41 includes the inverter 45. In step 203, the electric motor is manufactured using the assemblies produced in steps 201, 202.

Among the electric motors manufactured in step 200, some electric motors (one or more electric motors) are supplied as the electric motors for manufacturing the electric power steering apparatuses. In step 300, the electric power steering apparatuses are manufactured by using the supplied electric motors. Step 300 is carried out, for example, by a company (e.g., an automobile manufacturer or an in-vehicle system manufacturer), which is different from the one that carries out step 200.

Among the electric motors manufactured in step 200, remaining electric motors (one or more electric motors) are supplied as the electric motors for manufacturing the electric drive devices of the unmanned transport vehicles. In step 220, the electric drive devices are manufactured using the supplied electric motors and the speed reducers manufactured in step 210. The speed reducer manufactured in step 210 has the same configuration as the speed reducer 50 shown in FIG. 3.

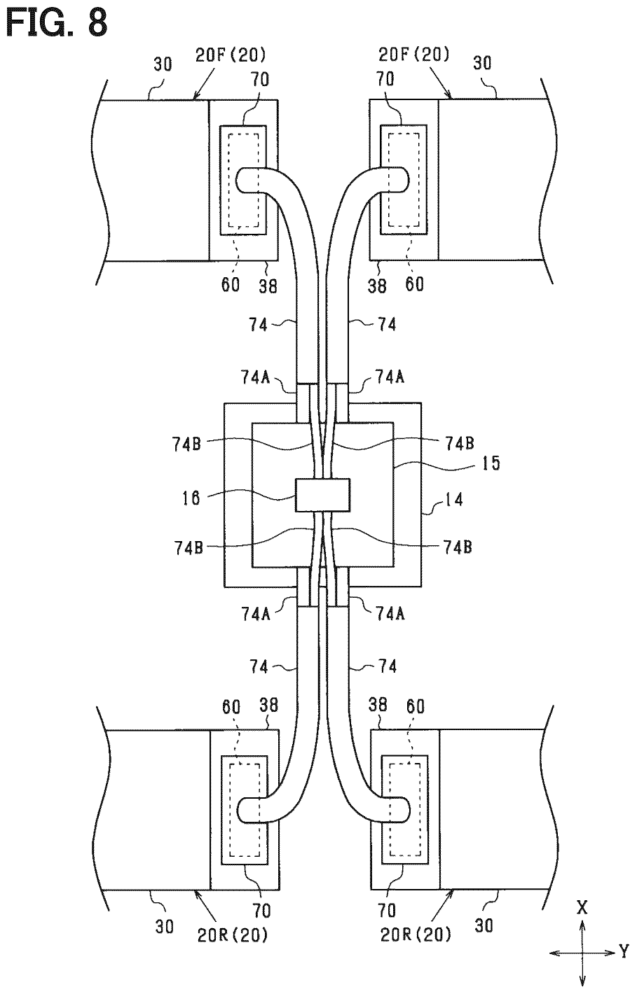

In step 400, the unmanned transport vehicles are manufactured using the electric drive devices manufactured in step 220. Step 400 is carried out, for example, by a company (e.g., a manufacturer of unmanned transport vehicles) different from the one that carries out steps 200, 210, 220. Specifically, in step 401, the portions of the unmanned transport vehicle, which are other than the electric drive devices, are manufactured. In step 402, the unmanned transport vehicle is manufactured by mounting the electric drive device onto the unmanned transport vehicle manufactured in step 401. At this time, since the cables 74 are connected in the manner shown in FIG. 8, the workability of the wiring operation can be improved.

The electric motor, which constitutes the power steering apparatus, is designed with a high level of safety. By using this electric motor in the compact electric vehicle, it is possible to manufacture the compact electric vehicle with higher safety.

Even in a case where the number of compact electric vehicles manufactured is small, an increase in the cost of the electric motors for the compact electric vehicles can be suppressed because the electric motors are commonized with the electric motors used in the power steering apparatuses for the automobiles, which are manufactured in larger quantities.

### Other Embodiments

The above-described embodiments may be modified as follows.

The voltage converter 15 may be eliminated from the compact electric vehicle. In such a case, each of the receptacles 60 and the electricity storage device 14 may be directly connected by the electric power cable 74A. In this case, the electricity storage device 14 serves as a direct current power source.

The speed reducer may be eliminated from the drive unit. In such a case, for example, the motor shaft 32 of the rotor 31 may serve as a shaft coupled to the drive wheel.

The structure is not limited to the one in which the electric power receptacle 60A and the communication receptacle 60B are integrated, and may instead be a structure in which the electric power receptacle 60A and the communication receptacle 60B are provided separately. In this case, a cable for electrically connecting between the electric power receptacle 60A and the voltage converter, and a cable for electrically connecting between the communication receptacle 60B and the host ECU 16, may be provided separately.

The microcontroller 47 of each drive unit and the host ECU 16 may communicate with each other wirelessly instead of using the wired communication. In such a case, the communication receptacle 60B and the communication cable 74B may be omitted.

The electric motor is not limited to the inner rotor type but may be an outer rotor type. Additionally, the electric motor is not limited to the radial gap type but may instead be an axial gap type.

The unmanned transport vehicle is not limited to the four-wheeled vehicle but may be a six-wheeled vehicle having three pairs of drive wheels, each pair being arranged in the vehicle width direction, or a two-wheeled vehicle with one pair of drive wheels. Additionally, the unmanned transport vehicle is not limited to the unmanned transport vehicle having all wheels as the drive wheels but may be an unmanned transport vehicle having one or more of the wheels as driven wheel(s).

The direction in which the motor shaft 32 extends is not limited to the vehicle width direction, and may instead be the vehicle length direction, for example. In this case, for example, the speed reducer may include a worm wheel, and the rotational drive force may be transmitted from the motor shaft 32 to the drive wheel via the worm wheel.

The unmanned transport vehicle used in the factories is not limited to the AGV but may be an Autonomous Mobile Robot (AMR).

Also, the compact electric vehicle is not limited to the unmanned transport vehicle, and may instead be, for example, a vehicle such as an electric wheelchair or a senior cart, having a maximum speed of 20 km/h or lower, 15 km/h or lower, or 10 km/h or lower.

The microcontroller, the ECU, and the control methods of the microcontroller and the ECU described in the present disclosure may be implemented by a dedicated computer including a processor and a memory, the processor being programmed to execute one or more functions embodied by a computer program. Alternatively, the microcontroller, the ECU, and the control methods of the microcontroller and the ECU described in the present disclosure may be implemented by a dedicated computer provided by configuring a processor using one or more dedicated hardware logic circuits. Alternatively, the microcontroller, the ECU, and the control methods of the microcontroller and the ECU described in the present disclosure may be implemented by one or more dedicated computers configured by a combination of a processor programmed to execute one or more functions and a memory, and one or more hardware logic circuits. Further, the computer program may also be stored in a computer-readable, non-transitory, tangible storage medium as instructions to be executed by a computer.

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A drive unit configured to be applied to an electric vehicle that includes a drive wheel and has a maximum speed of 60 km/h or lower, the drive unit comprising:
a shaft that is configured to apply a rotational drive force to the drive wheel;
an electric motor that includes:
a plurality of stator windings; and
a rotor which is configured to rotate the shaft;
an inverter that is electrically connected to the plurality of stator windings and is configured to supply an electric current to the plurality of stator windings when a switching control operation of the inverter is executed; and
a housing that receives the electric motor and the inverter, wherein:
the electric motor is configured to operate as an electric power steering motor for electric power steering in a vehicle that is configured to travel on public roads.

2. The drive unit according to claim 1, wherein a plurality of main components of the electric motor of the drive unit are the same as a plurality of main components of the electric power steering motor.

3. The drive unit according to claim 2, wherein the plurality of main components of the electric motor include a plurality of components that form a magnetic circuit of the electric motor.

4. The drive unit according to claim 2, wherein the plurality of main components of the electric motor include a plurality of components that form an electrical circuit configured to perform a drive control operation of the electric motor.

5. The drive unit according to claim 4, wherein the plurality of components, which form the electrical circuit, include:
the inverter;
a microcontroller which is configured to perform the drive control operation of the electric motor; and
a sensor which is used in the drive control operation of the electric motor.

6. The drive unit according to claim 2, wherein the electric motor of the drive unit has an output capacity that is the same as an output capacity of the electric power steering motor.

7. A method for manufacturing a drive unit configured to be applied to an electric vehicle that includes a drive wheel and has a maximum speed of 60 km/h or lower, wherein the drive unit includes:
a shaft that is configured to apply a rotational drive force to the drive wheel;
an electric motor that includes:
a plurality of stator windings; and
a rotor which is configured to rotate the shaft;
an inverter that is electrically connected to the plurality of stator windings and is configured to supply an electric current to the plurality of stator windings when a switching control operation of the inverter is executed; and
a housing that receives the electric motor and the inverter, the method comprising:
manufacturing the electric motor as one of a plurality of electric motors;
supplying one or more of the plurality of electric motors as an electric power steering motor used for manufacturing of an electric power steering apparatus and supplying another one or more of the plurality of electric motors as the electric motor for manufacturing of the drive unit; and
manufacturing the drive unit using the electric motor supplied as the electric motor for manufacturing of the drive unit.

8. The drive unit according to claim 1, wherein:
the drive wheel is one of a plurality of drive wheels of the electric vehicle;
the electric vehicle includes a direct current power source;
the drive unit is provided for each of the plurality of drive wheels; and
the drive unit provided for each of the plurality of drive wheels includes a receptacle that is provided on the housing, wherein the receptacle is configured to receive a plug of a cable, which is configured to electrically connect between the inverter and the direct current power source.

9. The drive unit according to claim 8, wherein in the drive unit provided for each of the plurality of drive wheels, the receptacle is provided on an upper portion of the housing in a state where a receptacle opening, which is formed in the receptacle, faces upward.

10. The drive unit according to claim 8, wherein:
the plurality of drive wheels of the electric vehicle include:
a front-side drive wheel which is located on a front side of the direct current power source in a vehicle length direction; and
a rear-side drive wheel which is located on a rear side of the direct current power source in the vehicle length direction;
a front-side unit, which is the drive unit configured to rotate the front-side drive wheel, is arranged alongside the front-side drive wheel in a vehicle width direction;
a rear-side unit, which is the drive unit configured to rotate the rear-side drive wheel, is arranged alongside the rear-side drive wheel in the vehicle width direction; and
in each of the front-side unit and the rear-side unit, the receptacle is provided on a side surface of the housing, which faces toward the direct current power source in the vehicle length direction, in a state where a receptacle opening, which is formed in the receptacle, faces toward the direct current power source in the vehicle length direction.

11. The drive unit according to claim 10, wherein:
in each of the front-side unit and the rear-side unit, the receptacle includes:
a positive terminal which is electrically connected to a high-potential side of the inverter; and
a ground terminal which is electrically connected to a low-potential side of the inverter; and
the ground terminal and the positive terminal are arranged in an up-down direction in a state where the ground terminal is positioned below the positive terminal.

12. The drive unit according to claim 8, wherein in the drive unit provided for each of the plurality of drive wheels, the receptacle is provided on a lower portion of the housing in a state where a receptacle opening, which is formed in the receptacle, faces downward.

13. The drive unit according to claim 8, wherein:
the plurality of drive wheels of the electric vehicle include:
a front-side drive wheel which is located on a front side of the direct current power source in a vehicle length direction; and
a rear-side drive wheel which is located on a rear side of the direct current power source in the vehicle length direction;
a front-side unit, which is the drive unit configured to rotate the front-side drive wheel, is arranged alongside the front-side drive wheel in a vehicle width direction;
a rear-side unit, which is the drive unit configured to rotate the rear-side drive wheel, is arranged alongside the rear-side drive wheel in the vehicle width direction; and
in each of the front-side unit and the rear-side unit, the receptacle is provided on a side surface of the housing, which faces away from the direct current power source in the vehicle length direction, in a state where a receptacle opening, which is formed in the receptacle, faces away from the direct current power source in the vehicle length direction.

14. The drive unit according to claim 8, wherein:
the plurality of drive wheels of the electric vehicle include:
a left-side drive wheel which is located on a left side of the direct current power source in a vehicle width direction; and
a right-side drive wheel which is located on a right side of the direct current power source in the vehicle width direction;
a left-side unit, which is the drive unit configured to rotate the left-side drive wheel, is arranged alongside the left-side drive wheel in the vehicle width direction;
a right-side unit, which is the drive unit configured to rotate the right-side drive wheel, is arranged alongside the left-side unit and the right-side drive wheel in the vehicle width direction; and
in each of the left-side unit and the right-side unit, the receptacle is provided on a side surface of an end portion of the housing, which faces toward a center between the left-side unit and the right-side unit in the vehicle width direction, in a state where a receptacle opening, which is formed in the receptacle, faces toward the center in the vehicle width direction.

15. The drive unit according to claim 8, wherein:
the electric vehicle includes a steering mechanism which couples between a vehicle body of the electric vehicle and the drive wheel and is configured to steer the drive wheel; and
the cable is configured to be extendable and contractible.

16. The drive unit according to claim 1, wherein the electric vehicle is an unmanned transport vehicle having a maximum speed of 10 km/h or lower.
